(19) United States
(12) Patent Application Publication
(10) Pub. No.: US 2006/0159093 A1
(43) Pub. Date: Jul. 20, 2006

(54) Broadcast splitter enabling selective transmission in real time

(75) Inventors: Young-Hun Joo, Yongin-si (KR); Chang-Sup Shim, Seoul (KR); Jun-Ho Koh, Suwon-si (KR); Kwan-Woong Song, Seongnam-si (KR); Yong-Deok Kim, Seoul (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/336,009

(22) Filed: Jan. 20, 2006

(30) Foreign Application Priority Data
Jan. 20, 2005 (KR) 2005-5454

(51) Int. Cl. H04L 12/56

(52) U.S. Cl. 370/390; 370/375

(57) ABSTRACT

Disclosed is a broadcast splitter enabling a selective transmission in real time. The broadcast splitter divides one multi-program transport stream (MPTS), which is obtained by multiplexing motion picture expert group-2 transport streams (MPEG-2TSs), into several single program transport streams (SPTSs). In particular, the broadcast splitter for MPEG-2TSs has a function of selecting a desired SPTS by performing a switching operation with respect to an MPTS in real-time without storing the MPTS when the MPTS is split into several SPTSs. Accordingly, it is possible to transmit MPTS signals in real time because desired TSs are extracted and delivered to output ports in real time by using a broadcast switch without storing the MPTS signals in a storage unit such as a RAM.

### CLAIM OF PRIORITY

This application claims priority to an application entitled “Broadcast Splitter Enabling Selective Transmission in Real Time,” filed in the Korean Intellectual Property Office on Jan. 20, 2005 and assigned Serial No. 2005-5454, the contents of which are incorporated herein by reference.

### BACKGROUND OF THE INVENTION

1. Field of the Invention

The present invention relates to a method of dividing one multi-program transport stream (MPTS), which is obtained by multiplexing motion picture expert group-2transport streams (MPEG-2TSs), into several single program transport streams (SPTSs), and more particularly to a broadcast splitter for MPEG-2TSs having a function of selecting a desired SPTS by performing a switching operation with respect to an MPTS in real-time without storing the MPTS when the MPTS is split into several SPTSs.

2. Description of the Related Art

In a digital broadcast service providing various broadcast contents, a broadcast system operator provides a multi-program transport stream (MPTS) by integrating the broadcast contents, so that a broadcast subscriber end can receive each broadcast content by splitting the MPTS into single program transport streams (SPTSs).

FIG. 1 illustrates a typical broadcast service system for providing a plurality of broadcast contents.

In operation, a broadcast system operator receives various digital broadcast contents, such as news 101, dramas 102, and soccer games 103, from a broadcast content provider. In addition, the broadcast system operator transmits an MPTS 100 by multiplexing the received digital broadcast contents.

A broadcast splitter 12 provided at the subscriber end splits the delivered MPTS into SPTSs 104-1 and 104-2 according to digital contents 101 and 102, and then provides the digital contents 101 and 102 according to the selection of the subscriber. The MPTS 100 is a broadcast stream including digital broadcast contents 101, 102, and 103 and can be split into the digital broadcast contents 101, 102, and 103 by means of the broadcast splitter 12 of a receiver by including information about program identifiers for the digital broadcast contents 101 102, and 103.

The broadcast splitter 12 is configured to split one MPTS, which is obtained by multiplexing several motion picture expert group-2 transport streams (MPEG-2TS) (digital broadcast contents), into several single program transport streams (SPTSs).

This broadcast splitter 12 is coupled with a zapping controller (not shown) at the subscriber side so as to allow a splitting and selection operation for a digital content desired by each subscriber.

Hereinafter, the structure of the conventional broadcast splitter 12 will be described.

FIG. 2 is a block diagram illustrating the structure of a re-MUX in accordance with the conventional broadcast splitter.

The re-MUX includes: a PID mapping modules 201-1 and 201-2 for receiving an MPTS and distinguishing between MPEG 2-TSs included in the received MPTS through PID mapping; a PID information table 209 for providing PID information to the PID mapping modules 201-1 and 201-2; input buffer 202-1 and 202-2 for temporarily storing output signals of the PID mapping module 201-1 and 201-2; a storage module 204 for storing MPEG 2-TSs included in the received MPTS; a scheduler 208 for providing scheduling information about the MPEG 2-TS to be re-multiplexed; a processing module 203 for storing MPEG 2-TSs included in MPTS input from the input buffers 202-1 and 202-2 in the storage module 204 and extracting and outputting MPEG 2-TSs stored in the storage module 204 according to scheduling information of the scheduler 208; output buffers 205-1, 205-2, 205-3, and 205-4 for storing the MPEG 2-TSs output from the processing module 203 and outputting the MPEG 2-TSs according to scheduling information of the scheduler 208; PCR correction modules 206-1, 206-2, 206-3, and 206-4 performing program clock reference (PCR) correction for synchronization of the MPEG 2-Ts output from the output buffers 205-1, 205-2, 205-3, and 205-4; and MUXs 207-1 and 207-2 for receiving output signals of the PCR correction modules 206-1, 206-2, 206-3, and 206-4 and multiplexing and outputting the output signals according to scheduling information of the scheduler. Herein, the storage module 204 may be constructed be a storage element such as a random access memory (RAM).

When MPTS#1 21 including TS #1 211, TS #2 212, and TS #3 213 and MPTS #2 22 including TS #4 221, TS #5 222, and TS #6 223 are input, the PID mapping modules 201-1 and 201-2 distinguish between the TSs through the PID mapping according to TSs using the PID information table 209 and then sequentially store all TSs 211, 212, 213, 221, 222, and 223 in the storage module 204 through input buffers 202-1 and 202-1 and the processing module 203. In addition, if broadcast signals (e.g., TS1 and TS5, and TS2 and TS4) to be re-multiplexed are determined through the scheduler 208, the processing module 203 extracts TSs selected from the storage module 204 and delivers the selected TSs to corresponding MUXs 207-1 and 207-2 through the output buffers 205-1, 205-2, 205-3, and 205-4 and the PCR correction modules 206-1, 206-2, 206-3, and 206-4 so that the MUXs 207-1 and 207-2 output new time division multiplexed MPTSs (e.g., an MPTS obtained through the combination of TS #1 and TS #5 and an MPTS obtained through the combination of TS #2 and TS #4).

However, the broadcast splitter requires more output ports than input ports. The re-MUX shown in FIG. 2 employs unnecessary MUXs for the output ports. The MUXs are components unnecessary for the broadcast splitter, which are used for combining several TSs.

FIG. 3 is a block diagram illustrating the structure of a broadcast splitter using the conventional re-MUX.

The re-MUX includes: PID mapping modules 301-1 and 301-2 for receiving an MPTS and distinguishing MPEG 2-TSs included in the received MPTS through PID mapping; a PID information table 309 for providing PID information to the PID mapping modules 301-1 and 301-2; input buffers 302-1 and 302-2 for temporarily storing output signals of the PID mapping modules 301-1 and 301-2; a storage module 304 for storing MPEG 2-TSs included in the received MPTS; a scheduler 308 for providing scheduling information about the MPEG 2-TSs to be re-multiplexed; a processing module 203 for storing MPEG 2-TSs included in the MPTS input from the input buffers 302-1 and 302-3 in the storage module 304 and extracting and outputting MPEG 2-TSs according to the MPEG 2-TSs stored in the storage module 304 according to scheduling information of the scheduler 308; output buffers 305-1 and 305-2 for storing MPEG 2-TSs output from the processing module 303 and outputting the MPEG 2-TSs according to scheduling information of the scheduler 308; PCR correction modules 306-1 and 306-2 for performing program clock reference (PCR) correction for synchronization of MPEG 2-Ts output from the output buffers 305-1 and 305-2; and MUXs 307-1 and 307-2 for receiving output signals of the PCR correction modules 306-1 and 306-2 and outputting the output signals according to scheduling information of the scheduler 308. Herein, the storage module 304 may be constructed be a storage element such as a random access memory (RAM).

When MPTS#1 31 including TS #1 311, TS #2 312, and TS#3 313 and MPTS #2 32 including TS #4 321, TS #5 322, and TS#6 323 are input, the PID mapping modules 301-1 and 301-2 distinguish the TSs through the PID mapping according to TSs using the PID information table 309 and then sequentially store all TSs 311, 312, 313, 321, 322, and 323 in the storage module 304 through input buffers 302-1 and 302-2 and the processing module 303. In addition, if broadcast signals (e.g., TS1 and TS4) to be re-multiplexed through the scheduler 308 are determined, the processing module 303 extracts TSs selected from the storage module 304 and delivers the selected TSs to corresponding MUXs 307-1 and 307-2 through the output buffers 305-1 and 305-2 and the PCR correction modules 306-1 and 306-2. As the MUXs 307-1 and 307-2 do not perform a multiplexing function, the MUXs may be removed from the broadcast splitter.

Since a broadcast splitter using the conventional re-MUX sends TSs to output buffers through the processing module after storing all input TSs in the storage module, when many TSs are required as a broadcast splitter used in an optical network unit (ONU) do, the load of the processing module increases, so the component of processing TSs in the broadcast splitter becomes complex. In addition, since the broadcast splitter processes TSs using a plurality of storage devices, such as a storage module, and output buffers as well as input buffers, time delay of each storage device occurs, so QoS (Quality of Service) for a real-time broadcasting service may suffer.

### SUMMARY OF THE INVENTION

Accordingly, the present invention has been made to solve the above-mentioned problems occurring in the prior art and provides additional advantages, by providing a broadcast splitter capable of enabling a selective transmission in real time which has a superior scalability because desired TSs are extracted and delivered in real time by using a broadcast switch without storing MPTS signals in a storage module, such as a RAM.

In one embodiment, there is provided a broadcast splitter for splitting a multi-program transport stream (MPTS) into several single program transport streams. The broadcast splitter includes a program identifier filter module for distinguishing motion picture expert group 2-transport streams included in the multi-program transport stream through a program identifier filtering by receiving the multi-program transport stream, a plurality of buffers for controlling input speeds of the motion picture expert group 2-transport streams by storing the motion picture expert group 2-transport streams output from the program identifier filter module, a transport stream switch for performing switching with respect to the motion picture expert group 2-transport streams by receiving the motion picture expert group 2-transport streams from the buffers and outputting the switched motion picture expert group 2-transport streams according to subscribers, a plurality of program clock reference correction modules employed for subscribers in order to perform a program clock reference correction for synchronization with respect to the motion picture expert group 2-transport streams according to subscribers output from the transport stream switch, and a controller for controlling the transport stream switch according to the channel selection information of each subscriber.

### BRIEF DESCRIPTION OF THE DRAWINGS

The above features and advantages of the present invention will be more apparent from the following detailed description taken in conjunction with the accompanying drawings, in which:

FIG. 1 illustrates a typical broadcast service system for providing a plurality of broadcast contents;

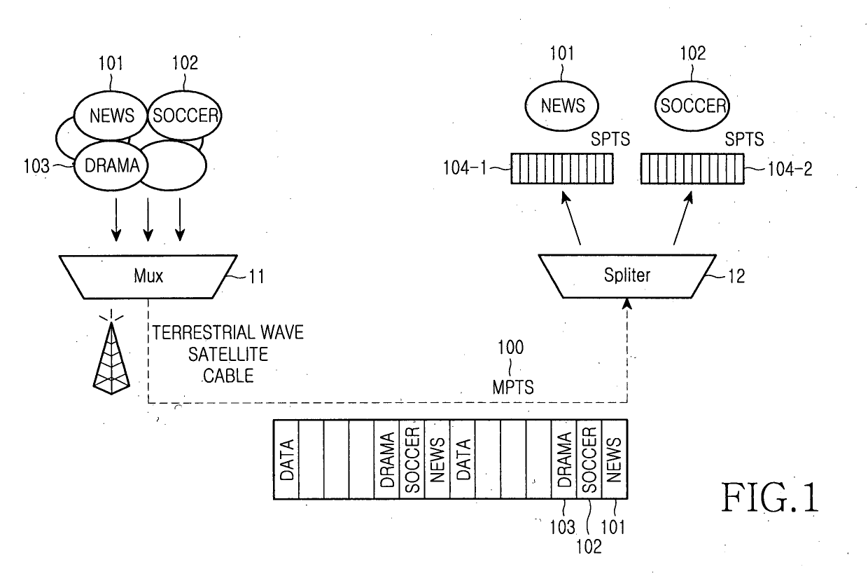

FIG. 2 is a block diagram illustrating the structure of a re-MUX applied to the conventional broadcast splitter;

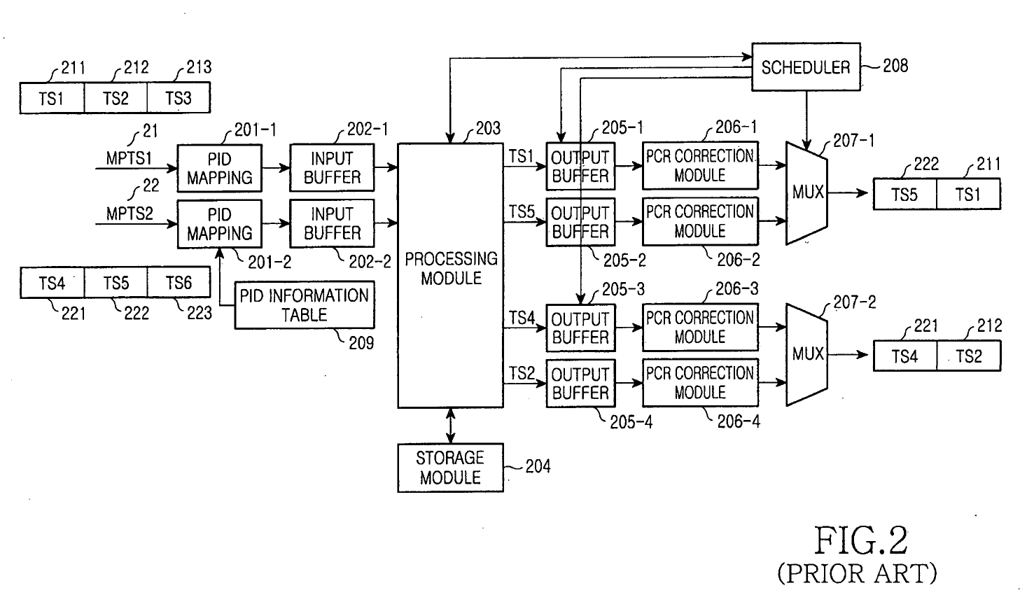

FIG. 3 is a block diagram illustrating the structure of a broadcast splitter using the conventional re-MUX; and

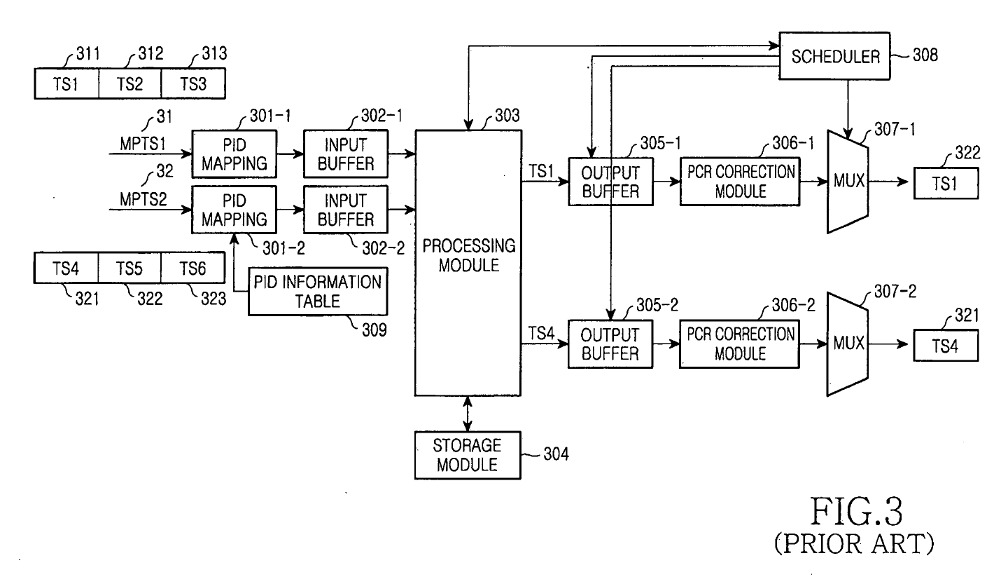

FIG. 4 is a block diagram illustrating the structure of a broadcast splitter enabling selective STP transmission in real time according to the present invention.

### DETAILED DESCRIPTION

Hereinafter, an embodiment of the present invention will be described in detail with reference to the accompanying drawings. For the purposes of clarity and simplicity, a detailed description of known functions and configurations incorporated herein will be omitted as it may make the subject matter of the present invention rather unclear.

Hereinafter, motion picture expert group 2-transport streams (MPEG 2-TSs) are not distinguished from single program transport streams (SPTSs). In other words, in the following description, each MPEG 2-TS has the same meaning as the SPTS.

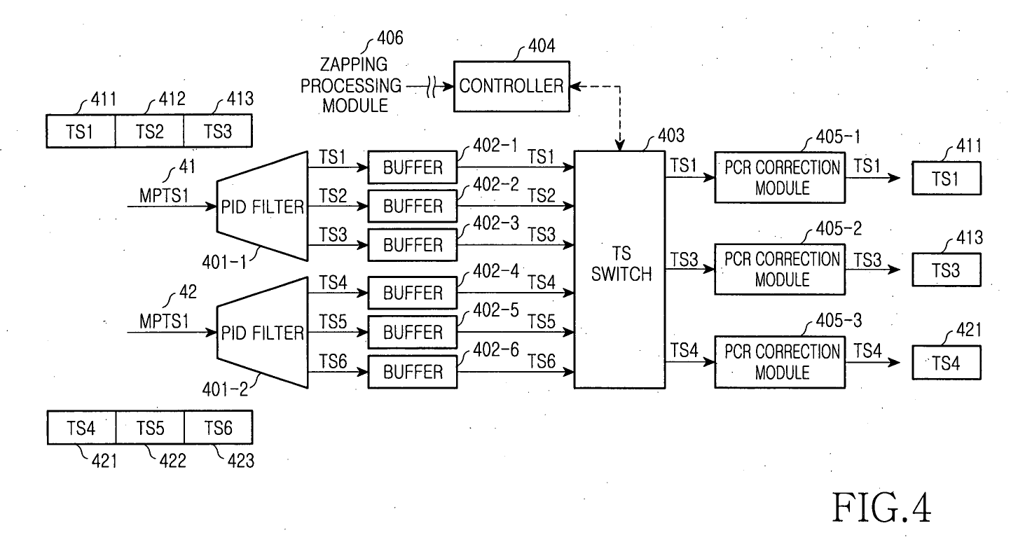

FIG. 4 is a block diagram illustrating the structure of a broadcast splitter enabling a selective transmission in real time according to the present invention.

As shown in FIG. 4, the broadcast splitter according to the present invention includes a TS switch 403 and performs directly a switching operation with respect to the TSs input based on the zapping information from a zapping processing module 406.

The broadcast splitter according to the present invention further includes program identifier (PID) filter modules 401-1 and 401-2 for receiving MPTSs and outputting the MPTSs by distinguishing MPEG 2-TSs included in the MPTSs through the PID filtering, buffers 402-1, 402-2, 402-3, 402-4, 402-5, and 402-6 for temporarily storing the MPEG 2-TSs output from the PID filter modules 401-1 and 402-2 in order to control the speed of the input MPEG 2-TSs, a transport stream (TS) switch 403 for receiving MPEG 2-TSs from buffers 402-1, 402-2, 402-3, 402-4, 402-5, and 402-6 and performing a switching operation with respect to input MPEG 2-TSs according to subscribers under the control of a controller 404, PCR correction modules 405-1, 405-2, and 405-3 for performing a program clock reference correction for synchronization with respect to MPEG 2-TSs output from the TS switch 403 and switched according to subscribers, and a controller 404 for receiving the zapping information of each user from an external zapping processing module 406 and controlling the TS switch 403 according to the received zapping information.

Although the zapping processing module 406, which is a component for processing the channel selection information delivered from each user, is not included in a broadcast splitter in the present invention, information for switching is provided. However, the zapping processing module may be included in the structure in accordance with the teachings of the present invention.

In addition, the PID filter modules 401-1 and 401-2 include PID information tables for providing MPEG 2-TS information within a corresponding MPTS in order to distinguish the MPEG 2-TSs to be output.

Furthermore, the TS switch 403 has N input ports and M output ports and performs a switching operation by matching the input ports with the output ports according to the control of the control part 404. Further, it is possible to enhance the scalability of a broadcast splitter by varying the number of output ports.

When MPTS #1 41 including TS #1 411, TS #2 412, and TS#3 413 and MPTS #2 42 including TS #4 421, TS #5 422, and TS #6 423 are input, the PID filter modules 401-1 and 401-2 distinguish between MPEG 2-TSs using PID information and then output the MPEG2-TSs. The output MPEG 2-TSs are stored in buffers 402-1, 402-2, 402-3, 402-4, 402-5, and 402-6, respectively. The MPEG 2-TSs 411, 412, 413, 421, 422, and 423 input to the TS switch 403 through the buffers 402-1, 402-2, 402-3, 402-4, 402-5, and 402-6 are switched according the channel selection information of each subscriber using the controller 404, undergo PCR correction for synchronization through the PCR correction modules 405-1, 405-2, and 405-3, and then output to subscribers, respectively.

For example, if it is assumed that three subscribers are connected to the broadcast splitter according to the present invention, two MPTSs including a total of six MPEG 2-TSs 411, 412, 413, 421, and 423 are input.

In this case, if the subscribers requires channel information corresponding to TS #1 411, TS #3 413, and TS #4 421 among the input MPEG 2-TSs, the controller 404 delivers the channel information to the TS switch 403, and the TS switch 403 performs a switching operation with respect to the MPEG 2-TSs input from the buffers according to subscribers. In other words, subscriber # 1, subscriber #2, and subscriber # 3 are provided with TS# 1 411, TS #3 413, and TS #4 421, respectively.

If the broadcast splitter is constructed using such the TS switch 403, the structure of output ports is simple, and the switch includes ports, the number of which is identical to that of inputs, so it is possible to easily expand the broadcast splitter. In other words, as the number of subscribers increases, it is possible to easily increase output ports without additional components.

As described above, according to the present invention, it is possible to transmit MPTS signals in real time because desired TSs are extracted and delivered to output ports in real time by using a broadcast switch without storing the MPTS signals in a storage unit such as a RAM.

In addition, according to the present invention, it is possible to easily increase the number of output ports because the output structure of the broadcast splitter is simply constructed using a TS switch.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A broadcast splitter for splitting a multi-program transport stream (MPTS) into several single program transport streams, the broadcast splitter comprising:
a program identifier filter module for distinguishing motion picture expert group 2-transport streams included in the multi-program transport stream through a program identifier filtering by receiving the multi-program transport stream;
a plurality of buffers for controlling input speeds of the motion picture expert group 2-transport streams by storing the motion picture expert group 2-transport streams output from the program identifier filter module;
a transport stream switch for performing switching with respect to the motion picture expert group 2-transport streams by receiving the motion picture expert group 2-transport streams from the buffers and outputting the switched motion picture expert group 2-transport streams according to subscribers;
a plurality of program clock reference correction modules for performing a program clock reference correction for synchronization with respect to the motion picture expert group 2-transport streams according to the subscribers output from the transport stream switch; and
a controller for controlling the transport stream switch according to a channel selection information of each subscriber.

2. The broadcast splitter as claimed in claim 1, wherein the controller receives the channel selection information of each subscriber from an external zapping processing module.

3. The broadcast splitter as claimed in claim 1, wherein the program identifier filter module includes a program identifier information table providing a motion picture expert group 2-transport stream information within the multi-program transport stream in order to distinguish between the motion picture expert group 2-transport streams to be output included in the multi-program transport stream.

4. The broadcast splitter as claimed in claim 1, wherein the TS switch has N input ports and M output ports and performs a switching operation by matching the input ports with the output ports according to a control of the controller.

5. The broadcast splitter as claimed in claim 4, wherein a scalability of the broadcast splitter is enhanced by varying the M output ports.
